(19) United States
(12) Patent Application Publication
(10) Pub. No.: US 2020/0382346 A1
(43) Pub. Date: Dec. 3, 2020

(54) EFFICIENT SPARSE CHANNEL ESTIMATION BASED ON COMPRESSED SENSING

(71) Applicant: MITSUBISHI ELECTRIC CORPORATION, Tokyo (JP)

(72) Inventors: Hadi NOUREDDINE, Rennes cedex 7 (FR); Qianrui LI, Rennes cedex 7 (FR)

(73) Assignee: MITSUBISHI ELECTRIC CORPORATION, Tokyo (JP)

(21) Appl. No.: 16/322,619

(22) PCT Filed: Aug. 31, 2017
(86) PCT No.: PCT/JP2017/032388

§ 371 Date: Feb. 1, 2019

(30) Foreign Application Priority Data
Sep. 15, 2016 (EP) 16306171.6

(51) Int. Cl. H04L 25/02; H04B 17/10; H04B 7/02

(52) U.S. Cl. CPC H04L 25/0242; H04B 7/02; H04B 17/101

(57) ABSTRACT

The present invention relates to a method of channel estimation including: —reception of measurements from a transmitter having a plurality of transmit antennas at a receiver having a plurality of receive antennas; characterized in that the method includes: —a first determination of at least one set of angles of departure based on the received measurements, each angle of departure being associated to at least one path of the channel for a radio transmission between the transmitter and the receiver; —a second determination of a plurality of sets of at least one parameter based on the determined set of angles of departure, each set of at least one parameter being associated to a path of the channel for a radio transmission between the transmitter and the receiver.

### TECHNICAL FIELD

The present invention relates to channel estimation based on compressed sensing, and more specifically to the case where the channel matrix is expected to be sparse.

### BACKGROUND ART

Millimeter wave (mmWave) wireless communication, which makes use of carrier frequencies going from 30 gigahertz (GHz) to 300 GHz, is expected to be a key feature, for instance, for future 5G cellular systems. A major benefit of using such high frequencies is the availability of much greater spectrum for higher data rates.

### SUMMARY OF INVENTION

### Technical Problem

Millimeter wave propagation is especially characterized by high path loss in free space, high penetration loss through building materials, weak diffraction, and vulnerability to blockage. Therefore, highly directional adaptive antenna arrays at both transmission and reception sides have to be used for compensating propagation impairments and enabling cellular coverage over distances of few hundred meters.

Directional arrays are usually constructed using a very large number of antenna elements, for instance tens to several hundreds.

In addition to high directional gain, the use of large antenna arrays enhances spatial multiplexing since narrower beams can be realized.

Directional gain and spatial multiplexing can be achieved by a careful design of beamforming precoders and combiners at transmission and reception sides, respectively. This design relies on the amount of channel state information (CSI) available on the system, which can be obtained by a channel estimation method, as detailed below.

For instance, in a narrowband flat-fading channel with multiple-input/multiple-output (MIMO), the system can typically be modeled as:

y=Hx+n

where x and y are respectively the transmit and the receive vectors, n is the noise vector, and H is the channel matrix, which size is equal to the product between the number of transmit antennas and the number of receive antennas. Typically, the matrix H characterizes the channel transition, and each component Hᵢⱼ of H represents the channel gain from j^{th} transmit antenna to i^{th} receive antenna. With channel estimation methods, one generally tries to estimate the matrix H, or an expression of H in a particular basis (for instance, in angular domain).

Commonly, channel estimation can be done by transmitting training signals, also called pilots, which are known by the receiver. Then, at the receiver, measurements for channel estimation are obtained by processing the signals at receive antennas using combiners. The number of transmitted pilots is classically equal to the number of transmit antennas. When the number of transmit antennas is very large, as in the above-mentioned application, training overhead could become prohibitive as it would require a large percentage of available resources.

The channel is usually modeled as a contribution of propagation paths. In a narrowband communication, a path is described by four parameters: angle of departure (AOD) azimuth and elevation, angle of arrival (AOA) azimuth and elevation, amplitude and phase. In mmWave propagation, many paths are highly attenuated, and the number of paths with significant gain is expected to be small compared to the size of the channel matrix. Consequently, and due to the high directivity of antenna arrays, the channel matrix is expected to be sparse when expressed in the angular domain.

A matrix or a vector is said to be “sparse” if it only has a few non-zero entries compared to its dimension.

Channel sparseness has been exploited by several solutions for drastically reducing the needed number of transmitted pilots. These solutions are implemented, for instance, using compressed sensing (CS) algorithms.

Several works have proposed solutions for sparse channel estimation based on CS algorithms, and which are suitable for multi-user communications. Generally, these solutions implement greedy pursuit algorithms, such as orthogonal matching pursuit (OMP). These algorithms are processed in an iterative way. At each iteration, a new path contributing to the channel is identified and its amplitude and phase are estimated. The identification comprises a simultaneous recovery of AOD and AOA. Iterations are processed until a stopping criterion is met.

Such solutions have drawbacks. The computational complexity order for identifying one path is indeed proportional to the product of the numbers of antennas at transmitter and receiver. With tens to several hundred antennas at both transmitter and receiver, the complexity becomes very high for practical and fast implementation.

There is thus a need for a method with reduced computational complexity to efficiently estimate sparse channel.

### Solution to Problem

The invention relates to a method of channel estimation including a reception of measurements from a transmitter having a plurality of transmit antennas at a receiver having a plurality of receive antennas. More particularly, the method includes:
a first determination of at least one set of first angles based on the received measurements, each first angle being associated to at least one path of the channel for a radio transmission between the transmitter and the receiver;
a second determination of a plurality of sets of at least one parameter based on the determined set of first angles, each set of at least one parameter being associated to a path of the channel for a radio transmission between the transmitter and the receiver.

It is meant by “channel estimation” here above a determination of a set of possible signal propagation paths between the transmitter and the receiver, or in an equivalent way the estimation of any representation of the channel matrix in a particular basis (for instance in angular domain).

A “possible propagation path” designates a path having a significant gain. For instance, in highly directional systems for which processing is performed in angular domain, only a few paths have significant gain.

The first determination step can thus include a determination of first angles which correspond to possible propagation paths, noting that there might be several paths sharing the same first angle. Therefore, said propagation paths can be identified during the aforesaid second determination, by computing other parameters. According to a general approach of the invention, different parameters characterizing the propagation paths are estimated successively, instead of being estimated simultaneously. This feature reduces the computational complexity of the algorithm used for determining a path, and thus the global complexity of the entire channel estimation process.

In an embodiment, the angles determined during the first determination step can be angles of departure. In that embodiment, the second determination can include computation of angles of arrival associated to possible propagation paths for every angle of departure determined during the first determination. Phase or amplitude of a path associated to a pair of angles (one angle of departure and one angle of arrival) can thus be determined.

In other terms, AOAs are identified during the first determination. Then, propagation paths are identified during the second determination by computing their AOAs, noting that there might be several paths sharing the same AOD but with different AOAs. For a given AOD, the estimation of phase and amplitude of a path can thus be done during the second determination after finding the AOA.

With such a method, the complexity of first determination is proportional to the number of transmit antennas, and the complexity of second determination is proportional to the number of receive antennas. The overall complexity of the solution is equal to the sum of complexities these two determination steps. Thus, the complexity is no longer a function of the product of the numbers of antennas at transmission and reception, as for the existing solutions.

In an embodiment where the receiver has at least one combiner, the first determination includes estimating a set of at least one channel vector, each channel vector h_{a,j} being relative to one combiner among the at least one combiner of the receiver, based on the formula:

yⱼ=P*Dₜh_{a,j}*+n

where:

P is a matrix obtained with a set of signals transmitted from the transmitter;
P* denotes the conjugate transpose matrix of matrix P;
yⱼ is a vector of measurements available at the current combiner;
Dₜ is a matrix relative to the transmit antennas;
n is a measurement noise vector;
and h_{a,j}* denotes the conjugate transpose vector of channel vector h_{a,j}.

It is meant by “combiner” a device which delivers in output a combination (for instance, a linear combination) of signals received at receive antennas.

Dₜ can be relative, for instance, to the geometry of the transmit antennas. It can also account for antennas gain and radiation pattern.

The signals transmitted from transmitter to receiver can be known from the receiver. In that way, if the matrix Dₜ is also know, it is possible, based on received measurements at a combiner, to estimate the vector h_{a,j} associated to this combiner.

For multiple combiners, the channel vectors, expressed in the angular domain, share the same support of non-zero entries, or in other words same AODs for which channel paths exist. This is due to the fact that the physical propagation paths constituting these channels are the same.

At the end of this step, estimates ĥ_{a,j} of matrices h_{a,j} (where j is the index of a combiner out of the total number of combiners) associated to different combiners are available.

The second determination can thus include:
computing a set of vectors based on non-zero entries of the estimated set of at least one channel vectors;
for each computed vector v_{g} from said computed set of vectors, estimating a column H_{a,q} of a channel matrix Hₐ expressed in angular coordinates, based on the formula:

v_{g}=Q*DᵣH_{a,q}+n_{q}

where:
Q is a matrix relative to the at least one combiner;
Q* denotes the conjugate transpose matrix of matrix Q;
Dᵣ is a matrix relative to the receiver;
and n_{q} is an estimation noise vector.

Dᵣ can be a matrix relative to the geometry of the receiver. It can also account for antennas gain and radiation pattern.

In an embodiment, if ĥ_{a,j,q} denotes the q^{th} non-zero entry of h_{a,j}, a vector v_{q} (for q∈{1, 2, . . . , k}, where k is the number of non-zero entries of estimated vectors ĥ_{a,j} can be defined as:

v_{q}=[ĥ_{a,1,q}, . . . ,ĥ_{a,L}_{_{c}}_{q}]^{T}

where L_{c} is the number of combiners and (.)^{T} denotes the transpose operation.

Each vector v_{q} can be seen as a measurement vector for H_{a,q} and then can be used to estimate H_{a,q}. The estimation of all vectors H_{a,q} associated to propagation paths is thus equivalent to the estimation of the entire set of propagation paths.

In an alternative embodiment, the angles determined during the first determination step are angles of arrival, while the second determination includes computation of angles of departure associated to respective propagation paths. Phase or amplitude of a path associated to a pair of one angle of arrival and one angle of departure can thus be determined.

Alternatively, first angles include angles of departure and angles of arrival, and the first determination includes:
a determination of a set of angles of departure based on the received measurements, each first angle being associated to at least one path of the channel for a radio transmission between the transmitter and the receiver;
a determination of a set of angles of arrival based on the received measurements, each first angle being associated to at least one path of the channel for a radio transmission between the transmitter and the receiver.

The second determination can then consist in computing phases or amplitudes associated to possible propagation paths, based on determined angles of departure and angles of arrival.

In this embodiment, angles of departure and angles of arrival are determined during two separate steps, each step being performed based on the received measurements. Preferably, these two steps can be performed in parallel.

The set of possible paths is then the Cartesian product of the two determined sets. In the second determination, a set of propagation paths is sought among the set of possible paths, and amplitude and phase can be computed for each selected propagation path.

Typically, the first determination can be performed by a Simultaneous Orthogonal Matching Pursuit algorithm. This algorithm enables to jointly recover the support for all sparse vectors to estimate, and thus improves the recovery accuracy.

The second determination can be performed by an Orthogonal Matching Pursuit algorithm. One iteration of such algorithm can be used for recovering one propagation path. The Orthogonal Matching Pursuit algorithm is run once for every angle determined during the first determination. Several runs of this algorithm can be implemented in parallel and thus the execution of the process can be advantageously accelerated.

Another aspect of the invention relates to a channel estimation device, comprising:
a receiver for receiving measurements from a transmitter having a plurality of transmit antennas;
a circuit for:
   determining at least one set of first angles based on the received measurements, each first angle being associated to at least one path of the channel for a radio transmission between the transmitter and the receiver;
   determining a plurality of sets of at least one parameter based on the determined set of first angles, each set of at least one parameter being associated to a path of the channel for a radio transmission between the transmitter and the receiver.

A third aspect relates to a computer program product, comprising instructions for performing the method previously described, when run by a processor.

Other features and advantages of the method and device disclosed herein will become apparent from the following description of non-limiting embodiments, with reference to the appended drawings.

The present invention is illustrated by way of example, and not by way of limitation, in the figures of the accompanying drawings, in which like reference numerals refer to similar elements.

### BRIEF DESCRIPTION OF THE DRAWINGS

FIG. 1 is an example of classical hybrid architecture on which the present method can be applied.

FIG. 2 is a flow chart illustrating the different steps of the channel estimation method according to a possible embodiment of the present invention.

FIG. 3 is a flow chart describing a determination of AODs associated with existing propagation paths in a possible embodiment of the present invention.

FIG. 4 is a flow chart describing a determination of propagation paths in a possible embodiment of the present invention.

FIG. 5 is a possible embodiment for a device that enables the present invention.

### DESCRIPTION OF EMBODIMENTS

As previously mentioned, large antenna arrays can be employed in mmWave systems to overcome path losses in this frequency band.

The hardware of large arrays operating at mmWave is subject to a constraint that impacts the number and design of pilots and combiners that can be processed. Actually, for cost and power considerations, it can be difficult to assign a radio-frequency (RF) chain per antenna.

A common solution to reduce the number of RF chains is hybrid analog/digital MIMO architectures.

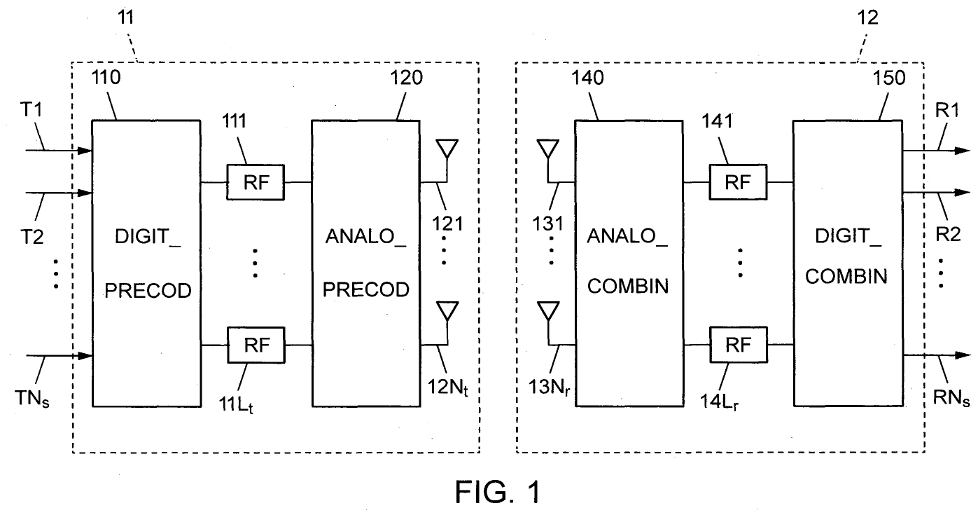

FIG. 1 is an example of classical hybrid architecture.

According to classical MIMO architectures, signals T1, T2, . . . , TNₛ can be transmitted by a transmitter 11 having a plurality of transmit antennas 121, . . . , 12Nₜ to a receiver 12 having a plurality of receive antennas 131, . . . , 13Nᵣ. In output of the receiver 12, signals R1, R2, . . . , RNₛ are delivered.

In hybrid architectures, processing is divided between analog and digital domains. At the transmitter side, precoding is then performed by a baseband digital precoding unit 110 and an RF analog precoding unit 120. The number, say Lₜ (with Lₜ≤Nₜ, where Nₜ denotes the number of transmit antennas), of digital branches is equal to the number of RF chains 111, . . . , 11Lₜ.

Similarly, at the receiver side, combining is performed by an RF analog combining unit 140 and a baseband digital combining unit 150. The number, say Lᵣ (with Lᵣ≤Nᵣ, where Nᵣ denotes the number of receive antennas), of digital branches is equal to the number of RF chains 111, . . . , 11Lᵣ.

The number of RF chains at both transmitter and receiver side are therefore lower than the number of transmit and receive antennas.

In a first embodiment the proposed invention can be used for instance, but without limitation, for the estimation of a narrowband block fading channel. This channel can be modeled by a baseband channel matrix, denoted here by H, which is a complex-valued matrix of size Nᵣ×Nₜ, Nᵣ and Nₜ being the numbers of antennas at reception and transmission, respectively.

The channel matrix H can also be expressed in the angular domain. The obtained matrix, denoted by Hₐ, is linked to H by the formula:

H=DᵣHₐDₜ*

where Hₐ is the channel matrix expressed in angular coordinates, and Dᵣ and Dₜ are basis (or dictionary) matrices which columns usually correspond to steering directions. X* denotes the conjugate transpose matrix of a matrix X.

As previously evoked, in mmWave propagation, only a few paths have significant gain due to high path attenuation and loss. When antenna arrays are highly directive, the channel matrix expressed in the angular domain, denoted by Hₐ, is usually sparse, which means that it only has a few non-zero entries.

One purpose of channel estimation can be estimating the (unknown) matrix Hₐ.

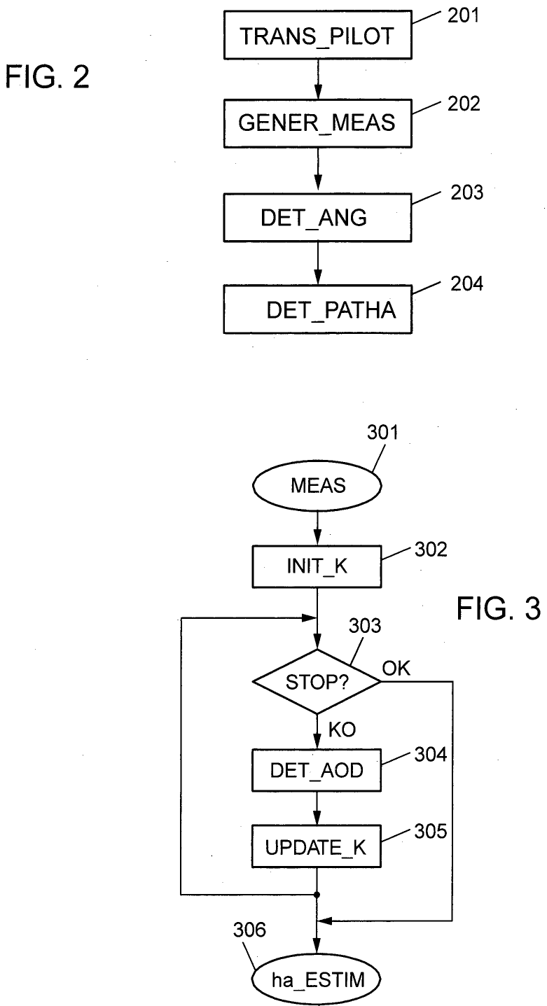

FIG. 2 is a flow chart illustrating the different steps of the channel estimation method according to a possible embodiment of the present invention.

In step 201, a set of Lₚ vector signals p₁, p₂, . . . , p_{L}_{ₚ}, also called “pilots” are transmitted from the transmitter to the receiver. These pilots are known by the receiver. In a first embodiment, pilots are not tailored to a specific receiver. In another embodiment they can be used for channel estimation by multiple receivers.

In step 202, L_{c} combiners q₁, q₂, . . . , q_{L}_{_{c}} are applied to signals received at reception antennas. This processing generates measurements which can be used for channel estimation.

For instance, a scalar measurement y generated from one pilot pᵢ and one combiner qⱼ, and collected at the associated output of the digital combining unit (element 150 of FIG. 1) can be modeled according to the following equation:

y=qⱼ*Hpᵢ+n

where n denotes (scalar) measurement noise, which can be assumed to be, for instance, zero-mean complex Gaussian noise.

At step 203, a determination of AODs associated with existing propagation paths is performed. By “existing” (or “possible”) propagation path, it is meant a path from an array of transmit antennas to an array of receive antennas, for which the gain is significant enough. In one embodiment, this determination step will thus be performed by fixing a criterion to evaluate either the gain of different paths is significant or not.

At step 204, a complete determination of propagation paths (for instance, the determination of other parameters such as AOAs, amplitudes and phases) is achieved, based on the AODs previously recovered. At the end of step 204, an estimate of the channel matrix in angular domain Hₐ is available.

In one embodiment, steps 203 and 204 can be performed at the receiver. In another embodiment, the architecture assumes channel reciprocity (for example in a frequency division duplex system), and these steps can be performed at transmitter using uplink pilots.

It will be noticed that in prior art, only one step is usually performed to determine simultaneously all the parameters (for instance, AODs and AOAs). In the present method, the determination of different parameters is done in two different steps (203 and 204).

Separating the determination of AODs on the one hand, and the estimation of other parameters associated to channels paths on the other hand, reduces the computational complexity of the algorithm.

For each determined propagation path, the complexity of first step is indeed proportional to the number of transmit antennas, and the complexity of step 2 is proportional to the number of receive antennas. The overall complexity of this solution is equal to the sum of complexities of steps 1 and 2. Thus, this complexity is not a function of the product of the numbers of antennas at transmission and reception, as for the existing solutions where AODs and AOAs are simultaneously recovered.

FIG. 3 is a flow chart describing a determination of AODs associated with existing propagation paths in a possible embodiment of the present invention. It presents a possible example of realization for step 203 of FIG. 2.

The transmission antennas and the output of one combiner qⱼ (j∈{1, . . . , L_{c}}) can be seen as a multiple input single output (MISO) system. The equivalent channel vector of this MISO system can be obtained by multiplying the MIMO channel matrix by the combiner vector, as follows:

hⱼ=qⱼ*H

The equivalent MISO channel vector can be expressed in angular coordinates as follows:

h_{a,j}=qⱼ*DᵣHₐ

In mmWave applications, vectors h_{a,j} are expected to be sparse. The entries of vectors h_{a,j} are associated to AODs. Estimating AODs of existing propagation paths can then be done by estimating the vectors h_{a,j}, based on a set of measurements 301 (this set is typically obtained at the end of the step 202 of FIG. 2).

For instance, if P=[p₁, . . . , p_{L}_{ₚ}] denotes the matrix composed by the Lₚ pilots p₁, p₂, . . . , p_{L}_{ₚ}, then, for each combiner qⱼ (j∈{1, . . . , L_{c}}), Lₚ measurements are available at the receiver and can be given by:

yⱼ=P*Dₜh_{a,j}*+nⱼ

where yⱼ is the measurement vector, and nⱼ is a measurement noise vector.

One combiner defines one MISO channel vector. For multiple combiners, the MISO channel vectors, expressed in the angular domain, share the same support of non-zero entries, or in other words same AODs for which propagation paths exist. This is due to the fact that the physical propagation paths constituting these channels are the same.

By jointly recovering the support for all these sparse vectors, the recovery accuracy is expected to be improved. Compressed Sensing (CS) tools provide several algorithms for joint sparse recovery. One such algorithm is, for instance, Simultaneous Orthogonal Matching Pursuit (SOMP), which is an iterative algorithm which identifies, at each iteration, a new non-zero entry of the sparse vectors. The iterations of the algorithm end when a stopping criterion is met. The stopping criteria can, for instance, be reaching a predefined number of iterations, or having a residual fall below a threshold. A residual is obtained by subtracting from the measurements the contributions of the already identified entries of the sought sparse vectors.

The AOD estimation procedure can then be described as follows:
In step 302, a counting variable k is thus initialized: k=0.
A test (step 303) is then realized to know if the stopping criterion is met or not:
If the criterion is met, the algorithm ends and the set of recovered AODs is produced in output;
Otherwise, an AOD associated to an existing path is determined (step 304), and added to the set of recovered AODs (step 305), the counting variable k is incremented (k←k+1), and the test 303 is realized again.

By the end of SOMP iterations, the output is estimates of the angular domain representations of MISO channel vectors. For the j^{th} combiner qⱼ, out of L_{c}, the algorithm provides an estimate ĥ_{a,j} of the equivalent channel expressed in angular coordinates h_{a,j}. At the end of the algorithm, a set of estimates ĥ_{a,1}, . . . , ĥ_{a,L}_{_{c}} (element 306) is available.

Let k denote the number of iterations of SOMP realized for the estimation of h_{a,j}. Then estimate vectors ĥ_{a,j} (for j∈{1, . . . , L_{c}}), have only k non-zero entries. The indices of these non-zero entries correspond to columns of Hₐ that are identified as non-equal to zero, or in other words, to AODs corresponding to propagation paths.

It can be notice that the procedure for estimating AODs not only requires the knowledge of pilots at the receiver, but also the knowledge of dictionary matrix Dₜ. In other words, the geometry of the transmitter antenna array needs to be known at receiver. Some parameters defining this geometry are, for instance, antenna spacing for a uniform linear array (ULA), number of antenna rows and columns and vertical and horizontal antenna spacing for a uniform planar array (UPA), or antenna polarization information.

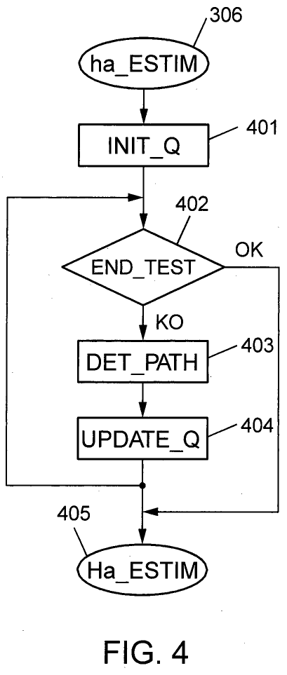

FIG. 4 is a flow chart describing a determination of propagation paths in a possible embodiment of the present invention. It presents a possible example of realization for step 204 of FIG. 2.

The inputs of the flow chart represented in FIG. 4 are the estimates ĥ_{a,1}, . . . , ĥ_{a,L}_{_{c}} previously determined. As said before, these vectors ĥ_{a,j} (for j∈{1, . . . , L_{c}}), have a fixed number k of non-zero entries.

Let ĥ_{a,j,q} denote the (scalar) q^{th} non-zero entry of ĥ_{a,j}, and define the following vector:

v_{q}=[ĥ_{a,1,q}, . . . ,ĥ_{a,L}_{_{c}}_{,q}]^{T}

where Y^{T} denotes the transpose vector of a vector Y. This vector can be written as:

v_{q}=Q*DᵣH_{a,q}+n_{q}

where Q=[q₁, . . . , q_{L}_{_{c}}] is the matrix of combiners, H_{a,q} is the q^{th} column of Hₐ identified as non equal to zero, and n_{q} is an estimation noise vector. The total number of columns of Hₐ identified as non equal to zero is k.

Vector v_{q} can be seen as a measurement vector for H_{a,q}, and can be used to recover H_{a,q} by means of a CS algorithm, for instance an Orthogonal Matching Pursuit (OMP) algorithm. The number of OMP iterations corresponds to the number of recovered paths for the AOD associated to H_{a,q}.

The propagation paths estimation procedure can then be described as follows:
In step 401, a counting variable q is initialized to 0 (q=0);
   In step 402, the current variable q is compared to k, to determine whether or not the procedure has to be stopped:
If q≤k (test KO), a recovery operation is applied to estimate H_{a,q} based on v_{q} (step 403); the counting variable q is then incremented (step 404: q←q+1);
   If q>k (test OK), the procedure ends and the complete set (405) of estimates Ĥ_{a,q} of H_{a,q} is delivered in output. It is then possible to construct an estimate Ĥₐ of matrix Hₐ based on the estimates Ĥ_{a,q}.

It has to be noticed that the procedure thus requires applying k recovery operations for the k vectors H_{a,q}(q∈{1, . . . , k}). In a preferred embodiment, these operations are implemented in parallel.

The estimate of Hₐ can be used for the design of beamforming precoders and combiners or for the feedback of CSI to the transmitter without the need to compute matrix H.

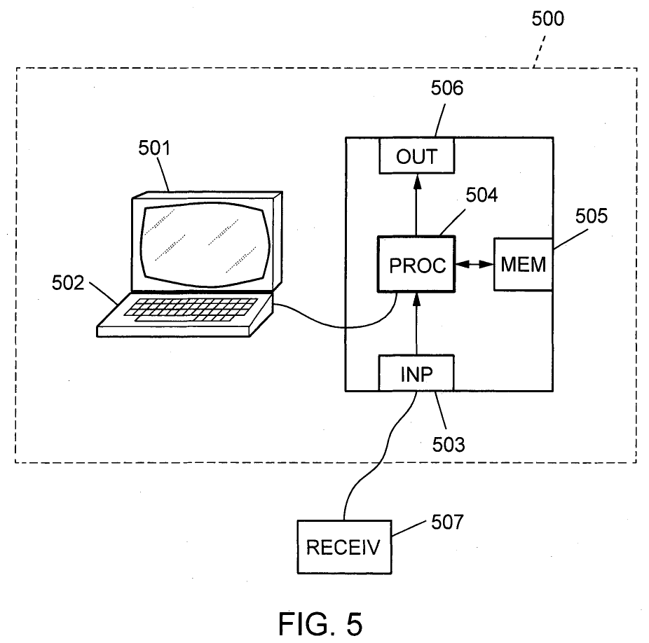

FIG. 5 is a possible embodiment for a device that enables the present invention.

In this embodiment, the device 500 comprise a computer, this computer comprising a memory 505 to store program instructions loadable into a circuit and adapted to cause circuit 504 to carry out the steps of the present invention when the program instructions are run by the circuit 504.

The memory 505 may also store data and useful information for carrying the steps of the present invention as described above.

The circuit 504 may be for instance:
a processor or a processing unit adapted to interpret instructions in a computer language, the processor or the processing unit may comprise, may be associated with or be attached to a memory comprising the instructions, or
the association of a processor/processing unit and a memory, the processor or the processing unit adapted to interpret instructions in a computer language, the memory comprising said instructions, or
an electronic card wherein the steps of the invention are described within silicon, or
a programmable electronic chip such as a FPGA chip (for «Field-Programmable Gate Array»).

This computer comprises an input interface 503 for the reception of measurements used for the above method according to the invention and an output interface 506 for providing either the set of estimated vectors Ĥ_{a,q} (with q∈{1, . . . , k}) or the estimated matrix Ĥₐ.

To ease the interaction with the computer, a screen 501 and a keyboard 502 may be provided and connected to the computer circuit 504.

Furthermore, the flow chart represented in FIG. 2 can represent steps of a program which may be executed by a processor located in the receiver, for instance. As such, FIG. 2 may correspond to the flow chart of the general algorithm of a computer program within the meaning of the invention.

In an alternative realization mode, the recovery order is reversed, and AOAs are firstly recovered, and remaining paths parameters are then recovered based on the estimated AOAs. Reversing the order could improve or deteriorate the recovery accuracy, depending on the number of antennas at transmission and reception and number of precoders and combiners.

The invention can be applied for the estimation of a frequency selective channel. For example, in an orthogonal frequency division multiplexing (OFDM)-like system, the paths constituting the MIMO channel matrices at multiple frequency sub-bands share the same AODs and AOAs but only differ in phases and amplitudes. A joint recovery of AODs and AOAs over multiple sub-bands or sub-carriers can thus improve the recovery accuracy. SOMP could be applied for this purpose. In a code division multiple access (CDMA)-like system or ultra-wide band (UWB)-like system, the invention can be applied to estimate the MIMO channel at the output of a correlator branch of the receiver. An example of a receiver in a CDMA system is a rake receiver with multiple correlator branches.

Alternatively, the first determination step can be applied twice, where the first application is for the determination of the set of angles of departure of possible paths, and the second application is for the determination of the set of angles of arrival of possible paths. The set of possible paths is then the Cartesian product of the two determined sets.

It is meant by “Cartesian product of two sets” A and B, the set of all ordered pairs (a,b), where a∈A and b∈B.

Then in step two, paths are sought among the set of possible paths and their amplitudes and phases are computed.

The present method can be used for many applications, such as cellular access between base stations and user equipments or terminals, backhaul between two edge cells or between an edge cell and core network, point-to-point and device-to-device communication, . . . .

Of course, the present invention is not limited to the embodiments described above as examples. It extends to other variants.

For example, this solution applies also when matrix Hₐ is not sparse but rather compressible. Hₐ is said to be compressible if it has a few dominant entries, and setting the non-dominant entries to zero does not result in significant error.

In an alternative realization mode, the AODs at the output of the first estimation procedure are fed back to the transmitter and exploited to design beamforming precoders. Then beamformed pilots are transmitted and used for recovering AOAs and designing beamforming combiners. The benefit of this strategy comes from the increased SNR of beamformed pilots.

1-14. (canceled)

15. A method of channel estimation including:
reception of measurements from a transmitter having a plurality of transmit antennas at a receiver having a plurality of receive antennas;
characterized in that the method includes:
a first determination of at least one set of first vectors based on the received measurements,
wherein coordinates of said first vectors are associated to first angles, each first angle being associated to at least one path of the channel for a radio transmission between the transmitter and the receiver; and
based on determined first vectors, a second determination of a set of second vectors,
wherein coordinates of said second vectors are associated to second angles, each second angle being associated to at least one path of the channel for a radio transmission between the transmitter and the receiver;
wherein said first angles and said second angles are respectively;
angles of departure and angles of arrival; or
angles of arrival and angles of departure.

16. The method according to claim 15, further including a determination of phases and/or amplitudes associated to at least one path of the channel for a radio transmission between the transmitter and the receiver, based on said first angles and said second angles.

17. The method according to claim 15, wherein said first angles and said second angles are respectively angles of departure and angles of arrival,
wherein the receiver has at least one combiner, and
wherein said first determination includes estimating a set of at least one channel vector, each channel vector h_{a,j} being relative to one combiner among the at least one combiner of the receiver, based on the formula:
yⱼ=P*Dₜh_{a,j}*+n
where:
P is a matrix obtained from a set of signals transmitted from the transmitter;
P* denotes the conjugate transpose matrix of matrix P;
yⱼ is a vector of measurements available at the current combiner;
Dₜ is a matrix relative to the transmit antennas;
n is a measurement noise vector;
and h_{a,j}* denotes the conjugate transpose vector of channel vector h_{a,j}.

18. The method according to claim 17, wherein the second determination includes:
computing a set of vectors based on non-zero entries of the estimated set of at least one channel vectors;
for each computed vector v_{q} from said computed set of vectors, estimating a column H_{a,q} of a channel matrix Hₐ expressed in angular coordinates, based on the formula:
v_{q}=Q*DᵣH_{a,q}+n_{q}
where:
Q is a matrix relative to the at least one combiner;
Q* denotes the conjugate transpose matrix of matrix Q;
Dᵣ is a matrix relative to the receiver;
and n_{q} is an estimation noise vector.

19. The method according to claim 15, wherein said first determination comprises performing a Simultaneous Orthogonal Matching Pursuit algorithm.

20. The method according to claim 15, wherein said second determination comprises performing an Orthogonal Matching Pursuit algorithm.

21. A channel estimation device, comprising:
a receiver for receiving measurements from a transmitter having a plurality of transmit antennas;
a circuit for:
determining at least one set of first vectors based on the received measurements, wherein coordinates of said first vectors are associated to first angles, each first angle being associated to at least one path of the channel for a radio transmission between the transmitter and the receiver; and
based on determined first vectors, determining of a set of second vectors, wherein coordinates of said second vectors are associated to second angles, each second angle being associated to at least one path of the channel for a radio transmission between the transmitter and the receiver; wherein said first angles and said second angles are respectively;
angles of departure and angles of arrival; or
angles of arrival and angles of departure.

22. A computer program product, comprising instructions for performing the method as claimed in claim 15, when run by a processor.
